(19) United States
(12) Patent Application Publication
(10) Pub. No.: US 2014/0312726 A1
(43) Pub. Date: Oct. 23, 2014

(54) LINEAR TRANSMISSION CYLINDER AND DRIVING MOTOR THEREOF

(71) Applicant: TIMOTION TECHNOLOGY CO., LTD., New Taipei City (TW)

(72) Inventor: Chou-Hsin WU, New Taipei City (TW)

(21) Appl. No.: 13/914,823

(22) Filed: Jun. 11, 2013

(30) Foreign Application Priority Data
Apr. 22, 2013 (TW) 102114127

(51) Int. Cl. H02K 7/116; H02K 5/04

(52) U.S. Cl. CPC H02K 7/1166; H02K 5/04
USPC 310/83

(57) ABSTRACT

A linear transmission cylinder with a driving motor includes a case, a stator disposed inside the case and a rotor having a rotary shaft disposed inside the case. The case includes a lower component and an upper component. The lower and upper components include a plurality of lower and upper ribs in an interval arrangement protruding from internal walls thereof and abutting an external wall of the stator, lower and upper shaft nests formed on rear interior walls thereof and lower and upper shaft bases formed on front interior walls thereof, such that the rotary shaft can be supported and pivoted thereon.

### BACKGROUND OF THE INVENTION

1. Field of the Invention

The present invention relates to a driving device, in particular, to a linear transmission cylinder and its driving motor which can transform rotation movement to linear movement.

2. Description of Related Art

A traditional linear transmission cylinder primarily has a driving motor, a transmission rod assembly, a worm gear and a worm wheel for driving the driving motor and the transmission rod assembly and a case covering the above-mentioned components. The driving motor has an enclosure, a stator and a rotor disposed inside the enclosure. Accordingly, the driving motor including the enclosure of the driving motor is disposed inside the case of the linear transmission cylinder. The case of the linear transmission cylinder provides positioning and limiting, such that the driving motor can be steadily disposed inside the case of the linear transmission cylinder. And the worm gear and the worm wheel can be driven to elevate the transmission rod assembly.

However, the volume of the case determines the occupancy of an article. Further, whether the case is shrunk to decrease the occupancy is determined by the internal components. The traditional linear transmission cylinder renders the case and the components therein to closely contact with one another, so as to decrease the occupancy. It has touched the ceiling. Therefore, it has to reconsider the necessary of the components while not affect the present function of the linear transmission cylinder so as to further decrease the occupancy.

In view of this, in order to solve the above problems, the applicant provides the present invention which is a reasonable design and can effectively solve the above problems by diligently researching and applying theory.

### SUMMARY OF THE INVENTION

The present invention is primarily to provide a linear transmission cylinder and its driving motor. The linear transmission cylinder has a case covering the driving motor, such that the driving motor is disposed inside the case. Accordingly, an enclosure material of the driving motor is eliminated. Specifically, the driving motor is a non-shell motor. The driving motor merely includes a stator and a rotor, such that the case of the linear transmission cylinder can directly position and limit the stator. Thus, the linear transmission cylinder can decrease the volume occupied by the driving motor so as to shrink the linear transmission cylinder.

In order to achieve the above-mentioned objective, the present invention provides a linear transmission cylinder with a driving motor, comprising a case, a stator disposed inside the case and a rotor disposed inside the case. The case includes a lower component and an upper component, and the lower component covers the upper component such that the case is hollow. The stator is disposed outside the rotor. The lower component includes a plurality of lower ribs in an interval arrangement protruding from an internal wall thereof, a concave lower shaft nest formed on a rear interior wall thereof and a lower shaft base formed on a front interior wall thereof. The upper component includes a plurality of upper ribs in an interval arrangement protruding from an internal wall thereof, a concave upper shaft nest formed on a rear interior wall thereof and a upper shaft base formed on a front interior wall thereof. The lower rib and the upper rib abut an external wall of the stator, and the rotor includes a rotary shaft having a rear end supported inside the upper shaft nest and the lower shaft nest and a front end pivoted on the upper shaft base and the lower shaft base.

In order to achieve the above-mentioned objective, the present invention provides a linear transmission cylinder, comprising a case, a stator disposed inside the case, a rotor disposed inside the case, a telescopic rod housing, a lead screw, a worm gear and a worm wheel. The telescopic rod housing extends from the lower component so as to carry the lead screw, the worm gear and the worm wheel. The case includes a lower component and an upper component, and the lower component covers the upper component such that the case is hollow. The stator is disposed outside the rotor. The lower component includes a plurality of lower ribs in an interval arrangement protruding from an internal wall thereof, a concave lower shaft nest formed on a rear interior wall thereof and a lower shaft base formed on a front interior wall thereof. The upper component includes a plurality of upper ribs in an interval arrangement protruding from an internal wall thereof, a concave upper shaft nest formed on a rear interior wall thereof and an upper shaft base formed on a front interior wall thereof. The lower rib and the upper rib abut an external wall of the stator, and the rotor includes a rotary shaft having a rear end supported inside the upper shaft nest and the lower shaft nest and a front end pivoted on the upper shaft base and the lower shaft base.

### BRIEF DESCRIPTION OF THE DRAWINGS

FIG. 1 is a perspective explosion view according to the present invention.

FIG. 2 is a perspective assembly view according to the present invention.

FIG. 3 is a cross-sectional view according to the present invention.

FIG. 4 is a sectional view according to another embodiment of the present invention.

### DETAILED DESCRIPTION OF THE INVENTION

In order to further realize technical features and technique contents of the present invention, the examiner is recommended to refer to the following detailed description and accompanying drawings of the present invention for reference purposes only instead of limiting the present invention.

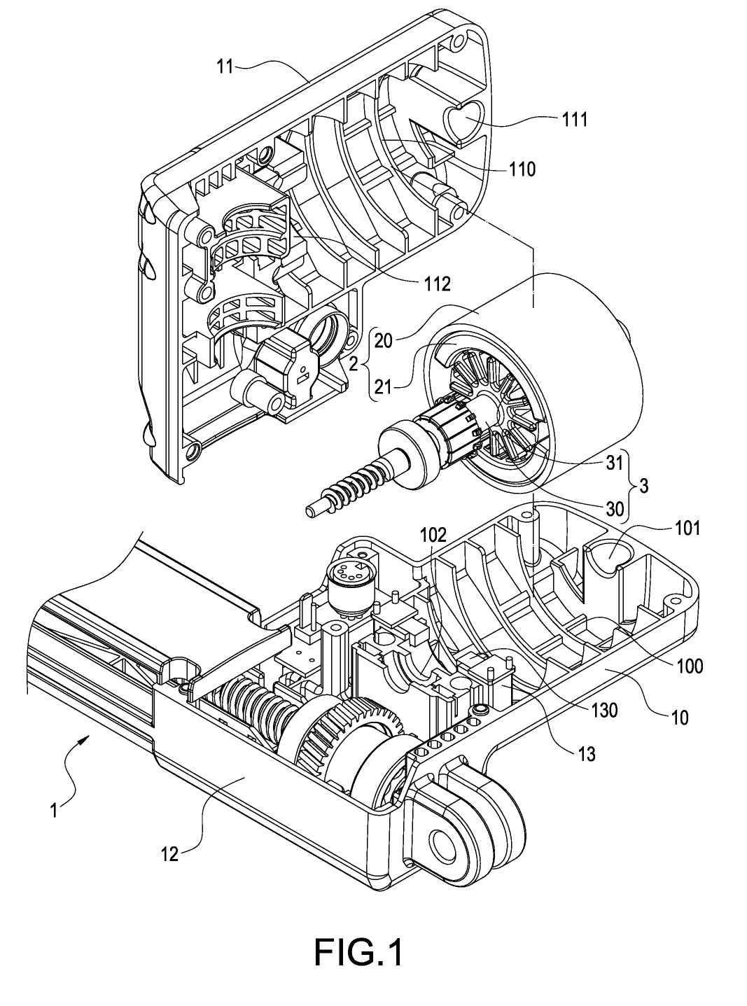

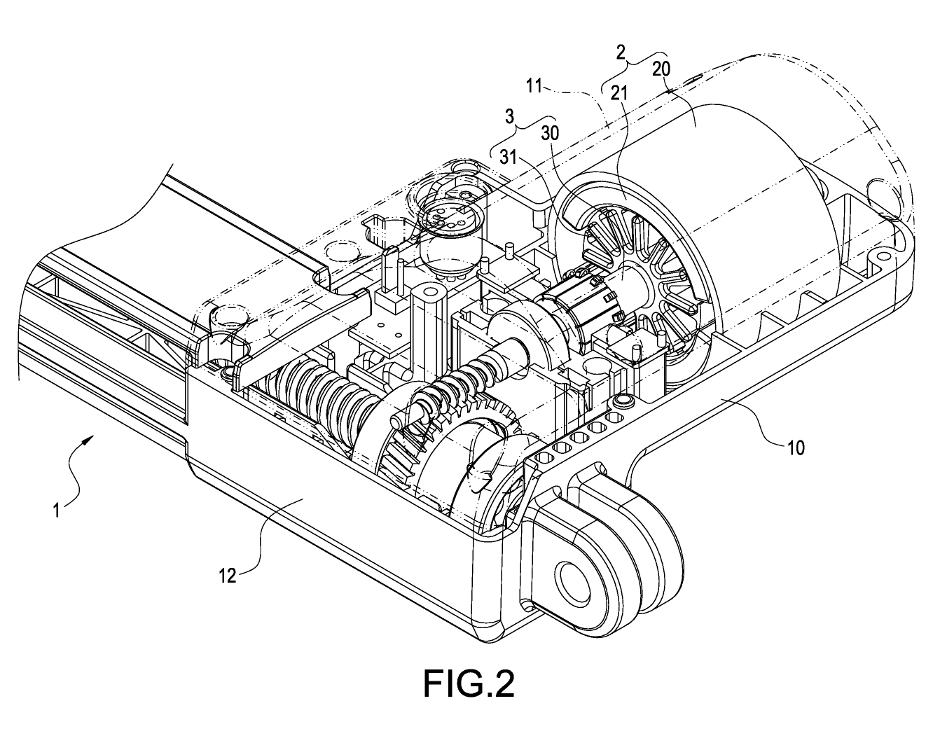

Please refer to FIG. 1 and FIG. 2, which are a perspective explosion view and a perspective assembly view according to the present invention, respectively. The present invention provides a linear transmission cylinder and its driving motor. The linear transmission cylinder comprises a case 1. The driving motor includes a stator 2 and a rotor 3.

The case 1 constitutes an enclosure of the linear transmission cylinder. The case 1 includes a lower component 10 and an upper component 11. The lower component 10 covers the upper component 11 such that the case 1 is hollow. The lower component 10 includes a telescopic rod housing 12 extending therefrom so as to carry other components of the linear transmission cylinder (such as, a lead screw, a worm gear a worm wheel and a deceleration gear set linked to the lead screw). The detailed structure of the telescopic rod housing 12 is not described herein.

The stator 2 and the rotor 3 are disposed inside the lower component 10 and the upper component 11, and the stator 2 is disposed outside the rotor 3. In the embodiment of the present invention, the stator 2 includes a hollow sleeve 20 and a plurality of magnetic elements 21 disposed on an internal wall of the sleeve 20. The rotor 3 includes a rotary shaft 30 and an induction coil 31 disposed on the rotary shaft 30. The induction coil 31 is located inside the sleeve 20 of the stator 2 and generates electromagnetic induction with respect to the magnetic element 21. Two brush holders 13 are disposed on two sides of the lower component 10 so as to correspond to two sides of the rotary shaft 30. A brush 130 is disposed inside the brush holder 13 so as to electrically contact the rotary shaft 30, such that the driving motor is constructed.

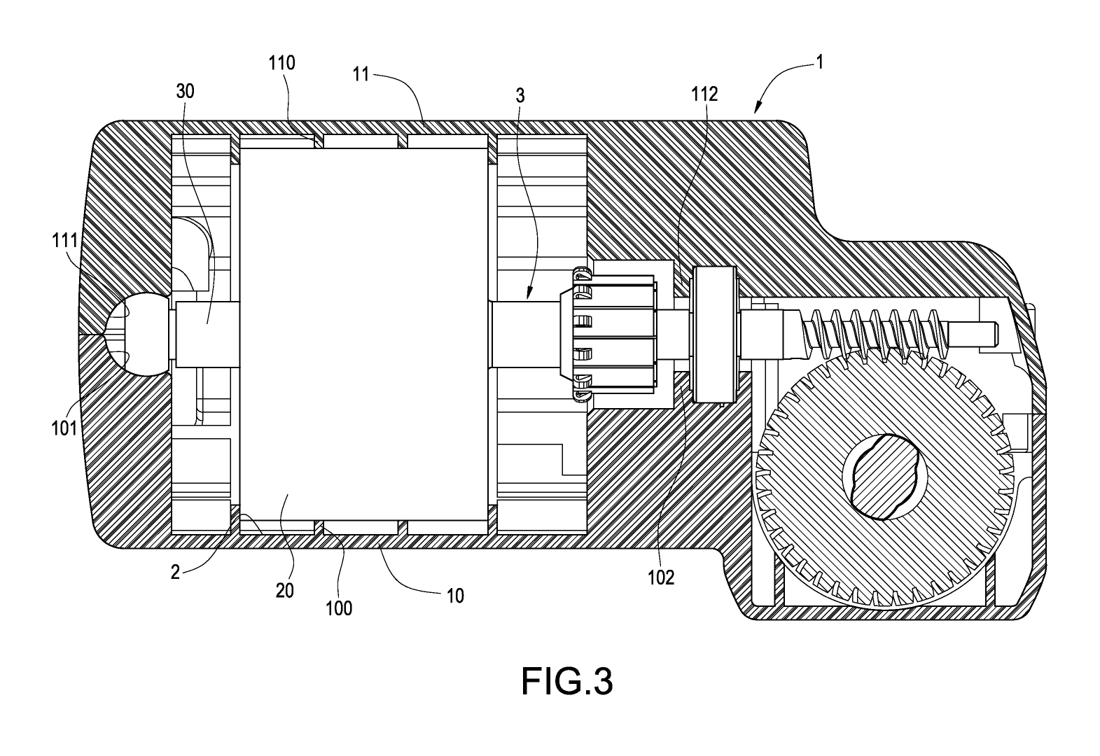

Please also refer to FIG. 3. In the present invention, structures for positioning and limiting the stator 10 and the rotor 11 are disposed on internal walls of the lower component 10 and the upper component 11 of the case 1, such that in the condition of the elimination of a enclosure material of the driving motor, the lower component 10 and the upper component 11 of the case 1 can be shrunk. Specifically, a plurality of lower ribs 100 in an interval arrangement protrude from the internal wall of the lower component 10, so as to abut an external wall of the stator 10. A plurality of upper ribs 110 in interval arrangement protrude from the internal wall of the upper component 11, so as to abut the external wall of the stator 10. Accordingly, the upper rib 110 and the lower rib 100 can render the upper component 11 and the lower component 10 closely abutted to the stator 10 so as to position or limit the driving motor. A concave lower shaft nest 101 is formed on a rear interior wall of the lower component 10, and a concave upper shaft nest 111 is formed on a rear interior wall of the upper component 11. A rear end of the rotary shaft 30 of the rotor 3 is supported inside the upper shaft nest 111 and the lower shaft nest 101. A lower shaft base 102 is formed on a front interior wall of the lower component 10, and an upper shaft base 112 is formed on a front interior wall of the upper component 11. A front end of the rotary shaft 30 of the rotor 3 is pivoted on the upper shaft base 112 and the lower shaft base 102. Accordingly, after the enclosure material of the driving motor is eliminated, the upper component 11 and the lower component 10 of the case 1 can directly position and limit the stator 2 and the rotary shaft 30 of the rotor 3 of the driving motor, such that the case 1 can be further shrunk. The present invention can achieve advantages of fewer parts, lower cost and simpler assembly.

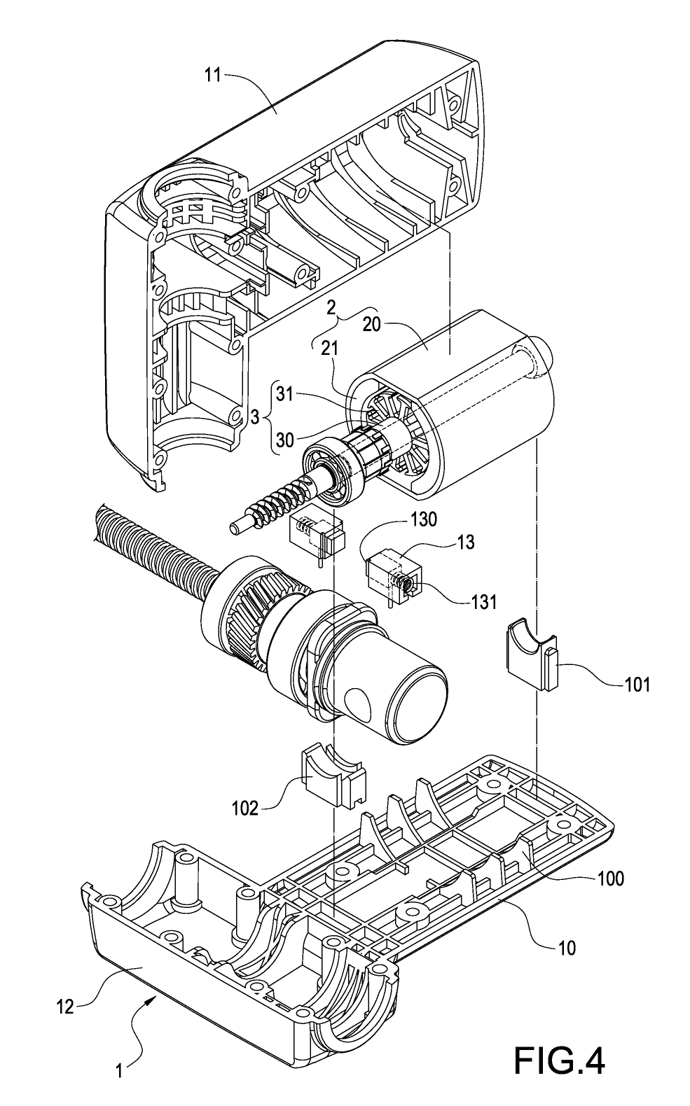

In addition, as illustrated in FIG. 4, in the present invention, a resilient element 131 is disposed inside the brush holder 13. The resilient element 131 biases the brush 130 to abut toward the rotary shaft 30, so as to maintain electrical contact between the brush 130 and the rotary shaft 30. Further, the lower shaft nest 101 and the lower shaft base 102 of the lower component 10 can be assembled on the internal wall of the lower component 10 in a detachable method. The detachable method can be, for instance, a concave and convex interference fit method.

Accordingly, the above-mention construction achieves the linear transmission cylinder and its driving motor of the present invention.

Specifically, in the linear transmission cylinder and its the driving motor of the present invention, the driving motor is covered by and directly disposed inside the case of the linear transmission cylinder which can provide positioning and limiting, so as to eliminate the enclosure material of the driving motor, and thus to shrink the whole structure.

In conclusion, the present invention can indeed achieve the objective and solve the deficiency of related art. In addition, it totally has novelty and obviousness and thus has patentability. Accordingly, this application is filed pursuant to the Patent Act and applies for the examination so as to protect the inventor.

The above-mentioned preferable embodiments of the present invention do not limit the claim scope of the present invention. All equivalent techniques and variations based on the specification and drawings of the present invention are involved in the scope of the present invention

What is claimed is:

1. A linear transmission cylinder with a driving motor, comprising:
a case (1) including a lower component (10) and an upper component (11), the lower component (10) covering the upper component (11) such that the case (1) is hollow;
a stator (2) disposed inside the case (1); and
a rotor (3) disposed inside the case (1), the stator (2) being disposed outside the rotor (3);
wherein the lower component (10) includes a plurality of lower ribs (100) in an interval arrangement protruding from an internal wall thereof, a concave lower shaft nest (101) formed on a rear interior wall thereof and a lower shaft base (102) formed on a front interior wall thereof; the upper component (11) includes a plurality of upper ribs (110) in an interval arrangement protruding from an internal wall thereof, a concave upper shaft nest (111) formed on a rear interior wall thereof and a upper shaft base (112) formed on a front interior wall thereof; the lower rib (100) and the upper rib (110) abut an external wall of the stator (2), and the rotor (3) includes a rotary shaft (30) having a rear end supported inside the upper shaft nest (111) and the lower shaft nest (101) and a front end pivoted on the upper shaft base (112) and the lower shaft base (102).

2. The linear transmission cylinder with the driving motor of claim 1, wherein the lower shaft nest (101) and the lower shaft base (102) of the lower component (10) are assembled on the internal wall of the lower component (10) in a detachable matter.

3. The linear transmission cylinder with the driving motor of claim 2, wherein the detachable matter is a concave and convex interference fit.

4. The linear transmission cylinder with the driving motor of claim 1, wherein the stator (2) includes a hollow sleeve (20) and a plurality of magnetic elements (21) disposed on an internal wall of the sleeve (20).

5. The linear transmission cylinder with the driving motor of claim 4, wherein the rotor (3) includes the rotary shaft (30) and an induction coil (31) disposed on the rotary shaft (30), and the induction coil (31) is located inside the sleeve (20) of the stator (2), such that the induction coil (31) and the magnetic element (21) produce electromagnetic induction.

6. The linear transmission cylinder with the driving motor of claim 5, wherein the lower component (10) further includes two brush holders (13) corresponding to two sides of the rotary shaft (30), respectively, and two brushes (130) disposed inside the two brush holders (13), respectively, and electrically contacting the rotary shaft (30).

7. The linear transmission cylinder with the driving motor of claim 6, wherein the lower component (10) further includes two resilient elements (131) disposed inside the two brush holders (13), respectively, and the resilient element (131) biases the brush (130) to abut toward the rotary shaft (30).

8. A linear transmission cylinder, comprising:
a case (1) including a lower component (10), an upper component (11), a telescopic rod housing (12), the lower component (10) covering the upper component (11) such that the case (1) is hollow;
a lead screw;
a worm gear;
a worm wheel, wherein the telescopic rod housing (12) extends from the lower component (10) so as to carry the lead screw, the worm gear and the worm wheel;
a stator (2) disposed inside the case (1); and
a rotor (3) disposed inside the case (1), the stator (2) being disposed outside the rotor (3);
wherein the lower component (10) includes a plurality of lower ribs (100) in an interval arrangement protruding from an internal wall thereof, a concave lower shaft nest (101) formed on a rear interior wall thereof and a lower shaft base (102) formed on a front interior wall thereof; the upper component (11) includes a plurality of upper ribs (110) in an interval arrangement protruding from an internal wall thereof, a concave upper shaft nest (111) formed on a rear interior wall thereof and a upper shaft base (112) formed on a front interior wall thereof; the lower rib (100) and the upper rib (110) abut an external wall of the stator (2), and the rotor (3) includes a rotary shaft (30) having a rear end supported inside the upper shaft nest (111) and the lower shaft nest (101) and a front end pivoted on the upper shaft base (112) and the lower shaft base (102).

9. The linear transmission cylinder of claim 8, further comprising a deceleration gear set linked to the lead screw.

10. The linear transmission cylinder of claim 9, wherein the lower shaft nest (101) and the lower shaft base (102) of the lower component (10) are assembled on the internal wall of the lower component (10) in a detachable matter.

11. The linear transmission cylinder of claim 10, wherein the detachable matter is a concave and convex interference fit.

12. The linear transmission cylinder of claim 8, wherein the stator (2) includes a hollow sleeve (20) and a plurality of magnetic elements (21) disposed on an internal wall of the sleeve (20).

13. The linear transmission cylinder of claim 12, wherein the rotor (3) includes the rotary shaft (30) and an induction coil (31) disposed on the rotary shaft (30), and the induction coil (31) is located inside the sleeve (20) of the stator (2), such that the induction coil (31) and the magnetic element (21) produce electromagnetic induction.

14. The linear transmission cylinder of claim 13, wherein the lower component (10) further includes two brush holders (13) corresponding to two sides of the rotary shaft (30), respectively, and two brushes (130) disposed inside the two brush holders (13), respectively, and electrically contacting the rotary shaft (30).

15. The linear transmission cylinder of claim 14, wherein the lower component (10) further includes two resilient elements (131) disposed inside the two brush holders (13), respectively, and the resilient element (131) biases the brush (130) to abut toward the rotary shaft (30).
